(19) United States
(12) Patent Application Publication
(10) Pub. No.: US 2010/0049927 A1
(43) Pub. Date: Feb. 25, 2010

(54) ENHANCEMENT OF DATA MIRRORING TO PROVIDE PARALLEL PROCESSING OF OVERLAPPING WRITES

(75) Inventors: Carlos F. Fuente, Southampton (GB); William J. Scales, Fareham (GB); John P. Wilkinson, Romsey (GB)

Correspondence Address: CANTOR COLBURN LLP - IBM TUSCON DIVISION, 20 Church Street, 22nd Floor, Hartford, CT, 06103, US

(73) Assignee: INTERNATIONAL BUSINESS MACHINES CORPORATION, Armonk, NY (US)

(21) Appl. No.: 12/195,769

(22) Filed: Aug. 21, 2008

(51) Int. Cl. G06F 12/16

(52) U.S. Cl. 711/162; 711/E12.103

(57) ABSTRACT

A storage unit including redundant storage includes: a primary storage unit and a journal for managing execution of incomplete writing of data for at least two overlapping data segments, a reference table for tracking incomplete writes of data; and includes instructions for managing data by: monitoring writes of data to identify incomplete writes of data sharing at least one designated storage location of a primary media; reading the associated writes of data into the table; sequencing the associated writes of data; writing data in sequence order to each designated storage location of the primary media and providing the data in sequence order to secondary media with a sequence number; and at least one secondary storage unit including a duplicate record of data comprised within the primary media, each secondary storage unit equipped for ensuring recent data is not overwritten with prior data by controlling writes according to the sequence number.

### TRADEMARKS

IBM® is a registered trademark of International Business Machines Corporation, Armonk, N.Y., U.S.A. Other names used herein may be registered trademarks, trademarks or product names of International Business Machines Corporation or other companies.

### BACKGROUND

1. Field of the Invention

This invention relates to redundant data storage, and particularly to parallel processing of overlapping writes in a computing infrastructure.

2. Description of the Related Art

It is common for data systems of today to use redundant storage. This provides users with high integrity data and great system reliability. However, designs for redundant storage systems are often complicated. Increased demands for performance continue to call for advancements in the design.

One design allows many writes to be handled in parallel across a remote copy relationship, applying them in order at the secondary location to maintain application power-fail consistency but providing negligible slowdown at the primary location. The combined design is able to maintain consistency even in the face of disruptions to the transmission operations, such as node failures or transient communication failures. But this ability is limited by using the primary copy of a disk as the known good copy of data, should retransmission be necessary. This results in a limitation to a single outstanding write for any given location on a secondary disk. This problem is known as a “colliding write” or “overlapping write” limitation. Any write which overlaps an earlier write must wait for the earlier write to be committed at the secondary location, and that result to be communicated to the primary site. As a result, the system committing the overlapping write will be forced to wait for the full round-trip delay of the primary write. This can, of course, result in degraded performance when compared with non-overlapping writes.

What are needed are techniques for improving performance of secondary writing in data storage systems. Preferably, the techniques mitigate or eliminate overlapping write limitations, and ensure integrity of data written to secondary storage units.

### BRIEF SUMMARY

The shortcomings of the prior art are overcome and additional advantages are provided through the provision of a storage unit including redundant storage and adapted for use in a processing system, the storage unit including: a primary storage unit for storing data and including a journal for managing execution of incomplete writing of data for at least two segments of data, wherein a designated storage location for the first write of data overlaps a least a portion of a designated storage location for the second write of data, wherein the journal includes a reference table for tracking incomplete writes of data; and, the journal includes machine executable instructions stored within machine readable media for performing the managing by: monitoring writes of data to identify incomplete writes of data sharing at least one designated storage location of a primary media; reading the associated writes of data into the reference table; sequencing the associated writes of data in the reference table; writing the data in the reference table in sequence order to each designated storage location of the primary media and providing the data in sequence order to associated secondary media with a respective sequence number; and; and at least one secondary storage unit including the secondary media and adapted for maintaining a duplicate record of data comprised within the primary media, each of the secondary storage units equipped for executing machine executable instructions stored within machine readable media, the instructions for ensuring most recent data stored on the secondary media is not overwritten with prior data by controlling writes to each storage location according the respective sequence number for the location on the secondary media.

Additional features and advantages are realized through the techniques of the present invention. Other embodiments and aspects of the invention are described in detail herein and are considered a part of the claimed invention. For a better understanding of the invention with advantages and features, refer to the description and to the drawings.

### TECHNICAL EFFECTS

As a result of the summarized invention, technically we have achieved a solution which software is used to provide a storage system with capabilities for rapid storage of overlapping data, particularly in systems implementing redundant arrays of storage devices. The solution ensures integrity of writes to secondary storage units that maintain duplicate copies of data stored in a primary storage unit.

### BRIEF DESCRIPTION OF THE SEVERAL VIEWS OF THE DRAWINGS

The subject matter which is regarded as the invention is particularly pointed out and distinctly claimed in the claims at the conclusion of the specification. The foregoing and other objects, features, and advantages of the invention are apparent from the following detailed description taken in conjunction with the accompanying drawings in which:

FIG. 1 illustrates one example of a processing system that makes use of a storage system as disclosed herein;

FIG. 2 illustrates aspects of a primary storage unit (e.g., a hard disk); and

FIG. 3 illustrates writes of overlapping data in relation to a primary media.

The detailed description explains the preferred embodiments of the invention, together with advantages and features, by way of example with reference to the drawings.

### DETAILED DESCRIPTION

Disclosed herein are methods and apparatus for ensuring integrity of writes to secondary storage by a processing system. Prior to discussing the invention in detail, some perspective is provided on a base design, for which the invention herein is provided as an improvement.

The solution provided includes an improvement to a scheme that includes a data journal for tracking overlapped writes. In general, data from a host for ongoing or incomplete writing of data (which may be referred to as “in-flight writes”) and subject to being overlapped is read into the journal before it is overwritten on the primary disk. Information from the journal and data maintained by the journal may be used for recovery.

Once the journal is established in non-volatile memory of the primary system, then an overlapping host write is released and can be applied to the primary storage and then completed to the host processing system, even while the overlapped write is still in flight to the secondary site. As a result, the host application at the primary site will experience an improved response time.

Improvements to this scheme are provided herein. Disclosed herein are methods and apparatus to ensure data within the secondary storage is always consistent. Before overlapping writes were handled in parallel, recovery due to a communications glitch could replay all the in-flight writes from the primary system. Because overlapping writes were not permitted, each write was “idempotent.” That is, each write would either have already been completed before the glitch and then be re-written with the same data, or it would not yet have been completed and would be written by sequence number, providing the users with consistency guarantees. With overlapping writes in flight in the processing system, it is possible for two writes to the same location to have completed, with the earlier write being replayed thus overwriting the later data with older data and destroying the consistency of the disk.

This is not acceptable, as the secondary disk must remain consistent at all times. The alternative of serializing and dispatching overlapping writes to the secondary system maintains consistency. However, with workloads that are predominantly overlapping, the serialization would soon cause the processing system to run out of sequence numbers and degrade to synchronous remote copy performance.

Care is taken in recovery to ensure that the overlapping writes do not create an inconsistent state. Having provided this introduction, consider now aspects of a processing system for practicing the teachings herein.

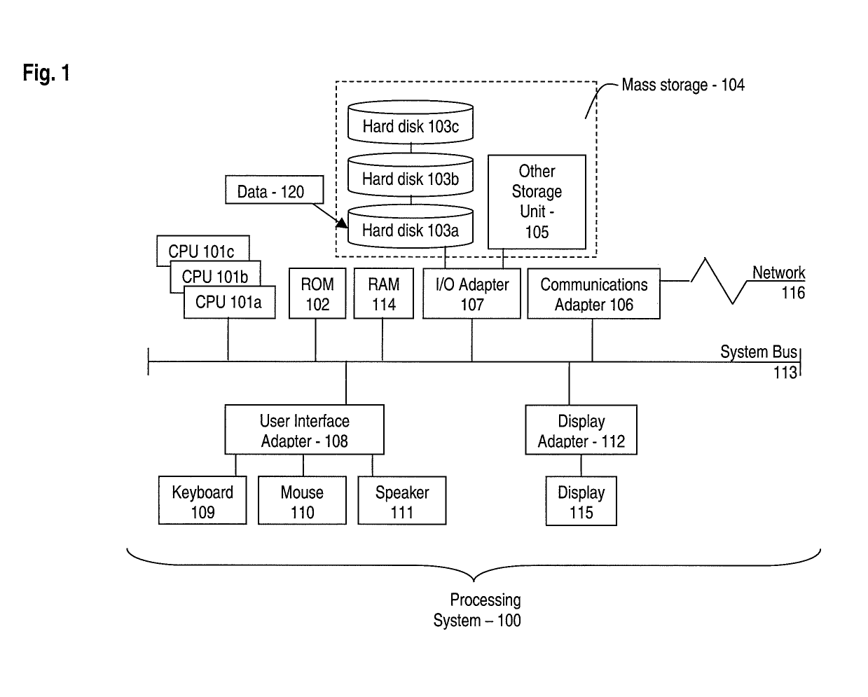

Referring to FIG. 1, there is shown an embodiment of a processing system 100 for implementing the teachings herein. In this embodiment, the system 100 has one or more central processing units (processors) 101a, 101b, 101c, etc. (collectively or generically referred to as processor(s) 101). In one embodiment, each processor 101 may include a reduced instruction set computer (RISC) microprocessor. Processors 101 are coupled to system memory 114 and various other components via a system bus 113. Read only memory (ROM) 102 is coupled to the system bus 113 and may include a basic input/output system (BIOS), which controls certain basic functions of system 100.

FIG. 1 further depicts an input/output (I/O) adapter 107 and a network adapter 106 coupled to the system bus 113. I/O adapter 107 may be a small computer system interface (SCSI) adapter that communicates with a mass storage unit 104. The mass storage unit 104 may include, for example, a plurality of hard disks 103a, 103b, 103c, etc, . . . and/or another storage unit 105 such as a tape drive, an optical disk, and a magneto-optical disk or any other similar component. A network adapter 106 interconnects bus 113 with an outside network 116 enabling data processing system 100 to communicate with other such systems. A screen (e.g., a display monitor) 115 is connected to system bus 113 by display adaptor 112, which may include a graphics adapter to improve the performance of graphics intensive applications and a video controller. In one embodiment, adapters 107, 106, and 112 may be connected to one or more I/O busses that are connected to system bus 113 via an intermediate bus bridge (not shown). Suitable I/O buses for connecting peripheral devices such as hard disk controllers, network adapters, and graphics adapters typically include common protocols, such as the Peripheral Components Interface (PCI). Additional input/output devices are shown as connected to system bus 113 via user interface adapter 108 and display adapter 112. A keyboard 109, mouse 110, and speaker 111 all interconnected to bus 113 via user interface adapter 108, which may include, for example, a Super I/O chip integrating multiple device adapters into a single integrated circuit.

Thus, as configured in FIG. 1, the system 100 includes processing means in the form of processors 101, storage means including system memory 114 and mass storage 104, input means such as keyboard 109 and mouse 110, and output means including speaker 111 and display 115. In one embodiment, a portion of system memory 114 and mass storage 104 collectively store an operating system such as the AIX® operating system from IBM Corporation to coordinate the functions of the various components shown in FIG. 1.

It will be appreciated that the system 100 can be any suitable computer or computing platform, and may include a terminal, wireless device, information appliance, device, workstation, mini-computer, mainframe computer, personal digital assistant (PDA) or other computing device.

Examples of operating systems that may be supported by the system 100 include Windows 95, Windows 98, Windows NT 4.0, Windows XP, Windows 2000, Windows CE, Windows Vista, Macintosh, Java, LINUX, and UNIX, or any other suitable operating system. The system 100 also includes a network interface 106 for communicating over a network 116. The network 116 can be a local-area network (LAN), a metro-area network (MAN), or wide-area network (WAN), such as the Internet or World Wide Web, or any other type of network 116.

Users of the system 100 can connect to the network 116 through any suitable network interface 106 connection, such as standard telephone lines, digital subscriber line, LAN or WAN links (e.g., T1, T3), broadband connections (Frame Relay, ATM), and wireless connections (e.g., 802.11(a), 802.11(b), 802.11(g)).

Of course, the processing system 100 may include fewer or more components as are or may be known in the art or later devised.

As disclosed herein, the processing system 100 includes machine readable instructions stored on machine readable media (for example, the hard disk 103). As discussed herein, the instructions are referred to as “software”. Software as well as data and other forms of information may be stored in the mass storage 104 as data 120.

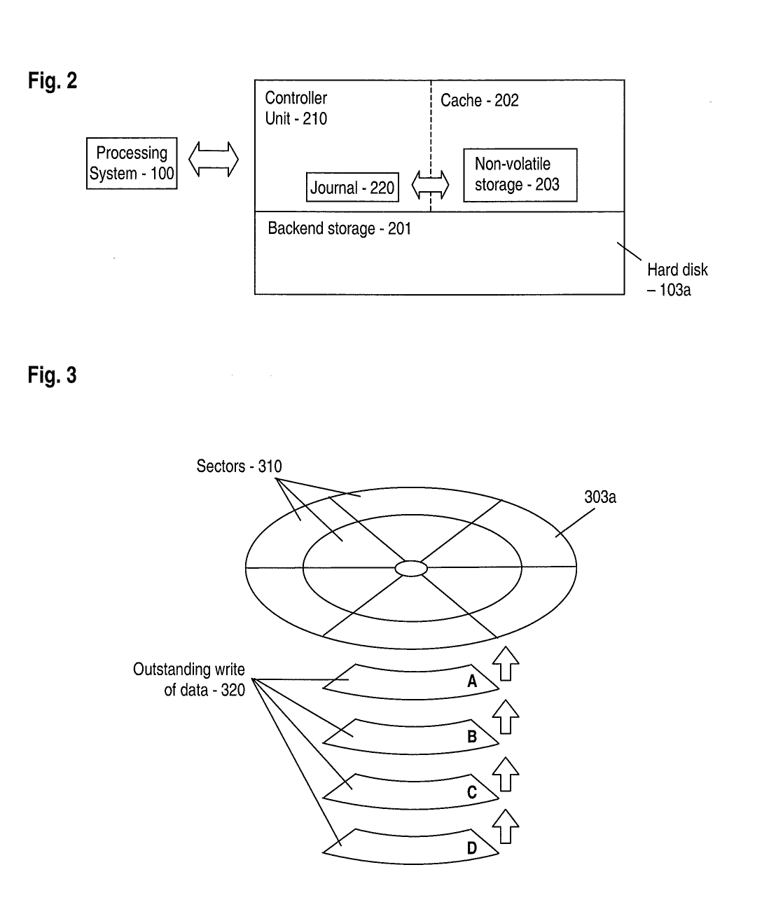

With reference to FIG. 2, the mass storage 104, or simply “storage” 104, may include any type of a variety of devices used for storing software 120, data and the like. In the example provided in FIG. 1, the storage 104 includes a plurality of hard disks 103a, 103b, 103c, . . . In this example, a first hard disk 103a is considered a primary hard disk, and used for initial writing. Secondary hard disks 103b, 103c may fulfill a variety of uses, including mirroring (i.e., duplication of) the primary hard disk 103a . Although each hard disc 103 may serve a specified purpose, in some embodiments, the actual structure of each hard disk 103 is identical to the structure of the other hard disks 103.

Generally, each device (such as the hard disk 103) provided as a component of the storage 104 includes a controller unit 210, a cache 202, and a backend storage 201. Non-volatile storage 203 (i.e., memory) may be included as an aspect of the controller unit 210, or otherwise included within the storage 104. The backend storage 201 generally includes machine readable media for storing at least one of software 120, data and other information as electronic information.

As is known in the art, the controller unit 210 generally includes instructions for controlling operation of the storage 104. The instructions may be included in firmware (such as within read-only-memory (ROM)) on board the controller unit 210, as an built-in-operating-system for the storage 104 (such as software that loads to memory of the controller unit 210 when powered on), or by other techniques known in the art for including instructions for controlling the storage unit 104.

In the example of FIG. 2, the primary hard disk 103a is shown. Included is a journal 220, which tracks “in-flight writes” of data. That is, the journal 220 provides a reference for tracking ongoing writing of data to secondary hard disks 103b, 103c, . . . The journal 220 may include a reference table, a data table, machine executable instructions for implementing a method for management of in-flight writes, and other such components. A sequence of multiple writes is better shown by FIG. 3.

In FIG. 3, a plurality of outstanding writes of overlapping data 320 are shown. In this example, each outstanding write of overlapping data 320 is in line for writing to a disk sector 310 of primary media 303a (i.e., media in the primary disk 103a).

When two writes are outstanding for a given location, the earlier write is referred to as an “overlapped” write, and the latter as the “overlapping” write. When more than two are writes are outstanding, each adjacent pair of the outstanding writes of overlapping data 320 have an overlapped and overlapping pair. For instance, with four outstanding writes of overlapping data 320 to the same location, A, B, C, and D, are dispatched in that order. In this example, D is the overlapping write for C, C is the overlapped write for D and the overlapping write for B, and so on. A write may also overlap multiple non-overlapping writes, for instance a write to disk sectors 0-9 may overlap a write to disk sectors 0-4 and another to disk sectors 5-9. Equivalently, a write may be overlapped by multiple overlapping and non-overlapping writes.

When the primary hard disk 103a receives an overlapping write (the write shares common locations with at least one outstanding write), the journal 220 does not permit the write of overlapping data 320 to proceed. Instead, the journal 220 triggers reading of the overlapped write or writes into a separate non-volatile storage 203. Detection of the outstanding writes of overlapping data 320 may be performed with a lock mechanism such as one used to prevent multiple overlapped writes being accepted from the host in parallel. Only when reads for all the overlapped writes 320 have completed is the overlapping write 320 allowed to proceed. The reads provide minimal slowdown, as the data will have just been written and so will be cached.

With both the overlapped and overlapping writes in flight, correct ordering is guaranteed by the sequence numbers attached to each of the writes. Re-reading into the buffer ensures that the overlapping and overlapped writes 320 do not share sequence numbers. The existing design can cope with the transmission of multiple mutually overlapping writes, and writing them on the secondary system.

In one embodiment, if there is a communication error, the journal 220 provides a protocol that disconnects, reconnects, and retransmits any writes that it has not had write completion of from the secondary system (i.e., secondary hard disks 103b, 103c, . . . ). For normal writes, the journal 220 will re-read data from the primary disk 103a for retransmission. For writes that have been overlapped, the journal 220 must use the data previously stored in the buffer of non-volatile storage 203.

Now with regard to ensuring integrity of writes to the secondary storage 103b, 103c, . . . problems associated with overlapping writes in the secondary storage are addressed by additional methods and apparatus. By storing the latest sequence number that the secondary system has completed, the processing system is provided with information that may be used to discard earlier sequence numbers during recovery. Thus, earlier writes are not used to overwrite later writes. This will eliminate overwriting data with older overlapped data, keeping the disk consistent. This also allows multiple writes to be in flight in parallel, severely lessening the impact of overlapped writes on host performance.

In one embodiment, each secondary storage unit 103b, 103c maintains a non-volatile store of the latest sequence number to be completed (written locally to a respective secondary storage unit), written as that sequence number completes. Before a sequence number that contains an overlapping write may be written, the secondary system must wait until the overlapped write's sequence number has been committed to the non-volatile store.

On recovery, sequence values in each unit of the secondary storage 103b, 103c are used and compared against incoming writes. Earlier writes may be discarded. An alternative implementation would be for the secondary system to communicate this latest sequence number back to the primary system before it replays the outstanding writes. The primary system could then replay from the sequence number following, ignoring earlier writes. This solution would be better for systems where minimizing recovery time is more important than messaging complexity.

The capabilities of the present invention can be implemented in software, firmware, hardware or some combination thereof As an example, the controller unit 210 may implement the journal 220 as machine executable instructions loaded from at least one of backend storage 201, non-volatile storage 203, local read-only-memory (ROM) and other such locations. The journal 220 may be implemented in other locations, such as on board the processing system 100.

As one example, one or more aspects of the present invention can be included in an article of manufacture (e.g., one or more computer program products) having, for instance, computer usable media. The media has embodied therein, for instance, computer readable program code means for providing and facilitating the capabilities of the present invention. The article of manufacture can be included as a part of a computer system or sold separately.

Additionally, at least one program storage device readable by a machine, tangibly embodying at least one program of instructions executable by the machine to perform the capabilities of the present invention can be provided.

The flow diagrams depicted herein are just examples. There may be many variations to these diagrams or the steps (or operations) described therein without departing from the spirit of the invention. For instance, the steps may be performed in a differing order, or steps may be added, deleted or modified. All of these variations are considered a part of the claimed invention.

While the preferred embodiment to the invention has been described, it will be understood that those skilled in the art, both now and in the future, may make various improvements and enhancements which fall within the scope of the claims which follow. These claims should be construed to maintain the proper protection for the invention first described.

What is claimed is:

1. A storage unit comprising redundant storage and adapted for use in a processing system, the storage unit comprising:
a primary storage unit for storing data and comprising a journal for managing execution of incomplete writing of data for at least two segments of data, wherein a designated storage location for the first write of data overlaps a least a portion of a designated storage location for the second write of data, wherein the journal comprises a reference table for tracking incomplete writes of data; and,
the journal comprises machine executable instructions stored within machine readable media for performing the managing by:
monitoring writes of data to identify incomplete writes of data sharing at least one designated storage location of a primary media;
reading the associated writes of data into the reference table;
sequencing the associated writes of data in the reference table;
writing the data in the reference table in sequence order to each designated storage location of the primary media and providing the data in sequence order to associated secondary media with a respective sequence number; and
at least one secondary storage unit comprising the secondary media and adapted for maintaining a duplicate record of data comprised within the primary media, each of the secondary storage units equipped for executing machine executable instructions stored within machine readable media, the instructions for ensuring most recent data stored on the secondary media is not overwritten with prior data by controlling writes to each storage location according the respective sequence number for the location on the secondary media.
